(19) United States
(12) Patent Application Publication
(10) Pub. No.: US 2012/0112021 A1
(43) Pub. Date: May 10, 2012

(54) AGRICULTURAL MACHINE LINKAGE ARRANGEMENT

(76) Inventor: DAVE KEMPERS, Arnhem (NL)

(21) Appl. No.: 13/283,664

(22) Filed: Oct. 28, 2011

(30) Foreign Application Priority Data
Oct. 29, 2010 (DE) 10 2010 043 138.9

(51) Int. Cl. A01B 63/00; A01B 63/02; A01B 63/24; F16M 13/02

(52) U.S. Cl. 248/201

(57) ABSTRACT

An agricultural machine including a linkage arrangement for moving an attached device. The linkage arrangement includes a first linkage having a plurality of mutually coupled connectors, a secured part, and a pivotal part. The linkage arrangement includes a second linkage having a plurality of mutually coupled connectors, a first pivotal part which can pivot together with the pivotal part of the first linkage, and a second pivotal part that is pivotal in relation thereto. The connectors of the first linkage extend from the secured part in the direction of the first pivotal part of the second linkage. The connectors of the second linkage extend from the first pivotal part of the second linkage in the direction of the secured part of the first linkage. One of the connectors of the first linkage is connected to one of the connectors of the second linkage by way of a joining connector.

### CROSS-REFERENCE TO RELATED APPLICATIONS

This application claims priority under 35 U.S.C. §119 to German patent application DE 10 2010 043 138.9, filed on 29 Oct. 2010, the disclosure of which is incorporated herein by reference.

### FIELD OF THE DISCLOSURE

The present disclosure generally relates to a linkage arrangement, and more particularly to a linkage arrangement of an agricultural machine for moving an attached device.

### BACKGROUND OF THE DISCLOSURE

The prior art discloses agricultural machines and vehicles which have a parallelogram linkage arrangement by means of which operational devices such as a sprayer linkage of an agricultural field sprayer are guided above the ground such that their height is adjustable. Parallelogram linkage arrangements of this kind typically have pivotal upper and lower connectors which are of equal length and are arranged on either side of the vehicle longitudinal axis, wherein the upper and lower connectors are each connected to a fixed connector, and a servo motor acts on one of the pivotal connectors.

A machine of this kind is disclosed for example in US 2007/0181710A1, which presents an agricultural field sprayer in the form of a trailer sprayer which has a parallelogram linkage arrangement for vertical movement of a sprayer linkage. Parallelogram linkage arrangements of this kind have the disadvantage that they have to be equipped with relatively long pivotal connectors. When the parallelogram linkage is moved in the vertical direction, the center of gravity of the sprayer linkage which is to be moved travels over a circular path which is defined by the length of the connectors. The longer the connector, the greater the radius of the circular path—the so-called swivel radius—can be, and so the smaller the movement of the center of gravity of the sprayer linkage in the horizontal direction. With a large swivel radius, a small shift in the center of gravity of the sprayer linkage is also advantageously produced, which is highly significant in the overall structure of an agricultural field sprayer, in particular in the case of a trailer sprayer. On the other hand, in order to keep the kinematic movements of a parallelogram linkage arrangement as compact as possible, it is desirable for the connectors of the parallelogram linkage arrangement to be as short as possible, especially since this also makes it possible to improve stability. However, this entails a smaller swivel radius, as a result of which relatively large horizontal movements of the attached device guided on the parallelogram linkage arrangement are produced during raising and lowering.

### SUMMARY OF THE DISCLOSURE

In one embodiment, an agricultural machine including a linkage arrangement for moving an attached device vertically, with small horizontal movements of the attached device, is disclosed. The linkage arrangement includes a first linkage having a plurality of mutually coupled connectors, a secured part that is secured to a frame of the machine, and a pivotal part that is pivotal in relation thereto. The linkage arrangement includes a second linkage having a plurality of mutually coupled connectors, a first pivotal part which can pivot together with the pivotal part of the first linkage, and a second pivotal part that is pivotal in relation thereto. The connectors of the first linkage extend from the secured part in the direction of the first pivotal part of the second linkage. The connectors of the second linkage extend from the first pivotal part of the second linkage in the direction of the secured part of the first linkage. One of the connectors of the first linkage is connected to one of the connectors of the second linkage by way of a joining connector such that they are connected to one another in an articulated manner.

Because the linkage arrangement is divided into at least two linkages, the individual linkages can be constructed to have reduced overall lengths per se, as a result of which a stable and compact construction of the linkage arrangement is made possible. At the same time, this type of linkage arrangement has the effect that an attached device that is pivotal vertically by the linkage arrangement performs relatively small horizontal movements. The reason for this may be found in the fact that, although the swivel radii of the individual compact linkages are relatively small because of their connectors, whereof the length is kept small, the horizontal movements of the individual pivotal parts of the linkages, which are consequently relatively large, may be compensated in part or almost entirely by their mutually opposing alignment, as a result of which a significantly smaller horizontal movement of the attached device overall can be achieved. This can bring advantages for the placement of the center of gravity of the attached device as it is moved vertically in relation to the overall structure of the agricultural machine.

The pivotal part of the first linkage and the first pivotal part of the second linkage may be formed by a common connector, but it is also conceivable to secure the second linkage to the pivotal connector of the first linkage by means of a separate connector.

The first and/or second linkage can take the form of a parallelogram linkage, but it is also possible to select other geometric arrangements of linkages, for example trapeziums or other multisided polygons.

Preferably, however, the first and the second parallelogram linkage each have an upper connector and, guided parallel thereto, a lower connector, wherein the joining connector extends from the lower connector of the first parallelogram linkage to the upper connector of the second parallelogram linkage. In the same way, the reverse arrangement is also advantageous, such that the first and the second parallelogram linkages each have an upper connector and, guided parallel thereto, a lower connector and the joining connector extends from the upper connector of the first parallelogram linkage to the lower connector of the second parallelogram linkage. Other constructions of connections are also conceivable as long as the movements of the one parallelogram linkage are coupled to the movements of the other parallelogram linkage.

Preferably, the upper or lower connector of the first or second parallelogram linkage has a portion which is prolonged by comparison with the lower connector or upper connector respectively of the corresponding parallelogram linkage, and the joining connector is articulated to this prolonged portion. The other end of the joining connector is articulated in a central region of the correspondingly other connector, to which it is secured. As a result of this type of articulation, a particularly advantageous sequence of movements of the pivotal part of the second parallelogram linkage is achieved, with small horizontal movements, for example if the joining connector is articulated in the central region of the lower connector of the first linkage and to the prolonged portion of the upper connector of the second linkage.

The linkage arrangement includes a servo motor which is connected to one of the connectors of the linkage arrangement. Actuation of the servo motor, which takes the form for example of an electric servo motor, a pneumatic or a hydraulic lifting cylinder or another type of actuator, can move the linkage arrangement, wherein the servo motor is articulated at one end to the frame of the machine or to a rigidly secured part of the first linkage and at the other end preferably to one of the upper or lower connectors of the first linkage.

The second linkage is connected to an attached device whereof the height in relation to the ground may be shifted by substantially vertical pivoting. Depending on the geometrical arrangement and construction of the linkage, and depending on the dimensions of the connectors and articulation points, height adjustments by different amounts may be achieved.

The agricultural machine may take the form of an automotive vehicle or a drawn vehicle. Thus, the agricultural machine may for example be a tractor or towing vehicle, a harvester, a seeder, a forestry machine, a spraying machine or a manure distributing machine. Similarly, a linkage arrangement of this kind is also suitable for use with drawn vehicles, for example trailer sprayers, seeders, soil working machines, manure spreaders, etc. Thus, the agricultural machine may take the form of a drawn agricultural spraying machine for applying crop protection agents. As already mentioned above, the agricultural machine may take the form of a sprayer or spraying machine. In this case, it may be a field sprayer that is drawn by an agricultural tractor or indeed an automotive field sprayer. It is further conceivable for the machine to take the form of an attached sprayer which is for example attached to an agricultural tractor by means of a three-point device. Other variants on the form taken by the machine are furthermore possible. Thus, the machine may for example take the form of a soil working machine which has one or more ploughshares or seeder units, guided by way of one or more linkage arrangements, or the like. It may further also be a mowing machine which has one or more mower attachments guided by way of linkage arrangements. It may furthermore also be an agricultural tractor and another agricultural vehicle which is automotive or indeed drawn by a tractor and which has a linkage arrangement. The linkage arrangement may be used to mount any attached device which is to be guided at variable distances above the ground. Further, other variants and embodiments of agricultural, forestry or horticultural machines which are readily apparent to those skilled in the art in the light of the description and which fall under the present disclosure are also possible.

The attached device may for example take the form of a sprayer linkage which is used in spraying machines for the application of spraying material. The sprayer linkage can in this case be connected to the pivotal part of the second linkage and be guided above the ground such that it is vertically adjustable, for dispensing the spraying material. As an alternative, the attached device may also take the form of a distributor linkage, for example for liquid manure and the like. The use of a blowing sprayer or spreading device as the attached device is also conceivable.

The linkage arrangement is constructed and geometrically arranged such that moving or pivoting the first linkage has the effect of arranging the pivotal part of the first and/or second linkage such that it is articulated substantially vertically in relation to the surface of the ground. This may be performed for example by a joining strut that extends from the pivotal part of the first and/or second linkage or by a connector, and this joining strut or connector is guided substantially vertically in relation to the surface of the ground. It is particularly advantageous that, when using an agricultural machine according to the disclosure, when the height of the attached device is adjusted only a very small horizontal movement is performed by the attached device and hence also only a small change is made to the torque acting on a vehicle axle. This means that fluctuations in force on the vehicle are reduced or minimized, which results for example in a more constant vertical force on a trailer coupling. These advantages may in turn be utilized in the overall structure of the vehicle, in that for example with a drawn spraying machine the capacity of the spraying agent tank may be increased or optimized, since an increase in the load on the trailer coupling when the sprayer linkage is pivoted or swiveled out is reduced or becomes negligible as a result of the small horizontal movement of the sprayer linkage. It is preferable, as described above, if the linkage arrangement is arranged to be pivotal substantially vertically in relation to the surface of the ground and serves substantially to pivot an attached device or an operational device or apparatus vertically. However, it is also conceivable to arrange the linkage arrangement to be pivotal horizontally such that corresponding attached devices or operational devices or apparatus are pivotal horizontally and may be moved over the ground at a constant distance from the ground but with a variable distance from the machine. Use of this kind would for example be useful in the case of blowing sprayers, which have adjustable outlet openings and by means of which spraying liquid may be sprayed on either side of the vehicle onto rows of plants laid out in different widths.

The agricultural machine may be used for a variety of types of attached devices, wherein the attached device is preferably, in particular in the case of a sprayer linkage, guided by way of two parallel linkage arrangements which extend on either side of the machine, with the linkage arrangements connected to one another by way of the attached device or sprayer linkage or by way of a joining frame. However, it is also conceivable to provide only one linkage arrangement on the machine and to arrange this for example centrally in relation to the machine and to construct it to be correspondingly stable.

Other features and aspects will become apparent by consideration of the detailed description and accompanying drawings.

### BRIEF DESCRIPTION OF THE DRAWINGS

FIG. 1 is a side view of an agricultural machine having a linkage arrangement according to one embodiment.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

### DETAILED DESCRIPTION

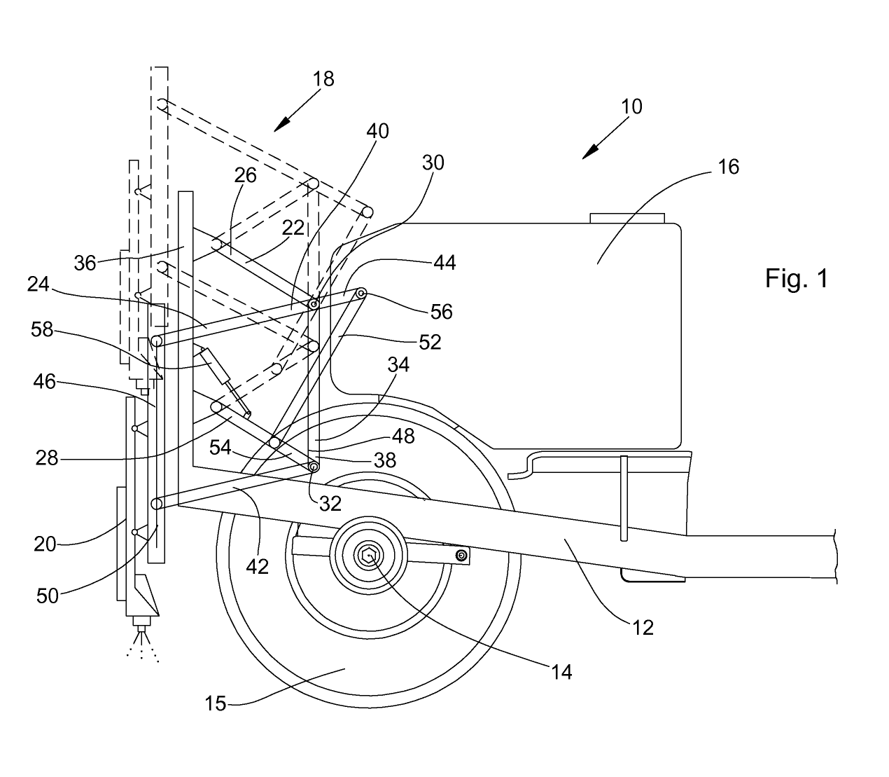

FIG. 1 illustrates an agricultural machine 10 in the form of an agricultural trailer sprayer. Alternatively, other forms of the agricultural machine 10 may be used and are contemplated in this disclosure. The agricultural machine 10 includes a frame 12, an axle 14 having wheels 15 arranged in a rear region of the frame 12, and a tank 16 which serves as a reservoir for a liquid to be sprayed. The machine 10 may be coupled to a tractor vehicle, for example an agricultural tractor, by way of trailer apparatus which is not shown.

A linkage arrangement 18 extends from the frame 12. An attached device 20 in the form of a sprayer linkage is mounted to the linkage arrangement 18. The attached device 20 is connected to the tank 16 by way of connection lines (not shown) and serves to dispense the liquid to be sprayed.

The linkage arrangement 18 has a first linkage 22 and a second linkage 24. The first linkage 22 has an upper and a lower connector 26, 28, which are guided mutually parallel. The upper and the lower connectors 26, 28 are secured in an articulated manner at one end to the frame 12, or to a secured part 36 rigidly secured to the frame 12, and extend from the frame 12 forwards towards the tank 16. At the other end the connectors 26, 28 are connected in an articulated manner, at an upper articulation point 30 and a lower articulation point 32, to a substantially vertical common connector 34 such that the connectors 26, 28, 34 and the rigidly secured part 36, form a parallelogram linkage. Thus, the common connector 34 forms a pivotal part 38, which is pivotal in relation to the frame 12 and the secured part 36.

The second linkage 24 has an upper and a lower connector 40, 42, which are guided mutually parallel. The lower connector 42 of the second linkage 24 is secured in an articulated manner at one end to the pivotal part 38 of the first linkage 22 at the lower articulation point 32 of the connector 34. The upper connector 40 of the second linkage 24 has a portion 44 which is prolonged by comparison with the lower connector 42. The portion 44 is secured in an articulated manner to the pivotal part 38 of the first linkage 22 at the upper articulation point 30 of the connector 34. The upper articulation point 30 is arranged between the ends of the upper connector 40 of the second linkage 24. The connector 34 thus forms a common connector 34 for the first and the second linkages 22, 24. The prolonged portion 44 of the upper connector 40 corresponds to approximately one third of the lower connector 42. The connectors 40, 42 of the second linkage 24 extend rearwards in relation to the machine 10 from the pivotal part 38 of the first linkage 22 and from the connector 34 or from the respective articulation points 30, 32, that is to say in opposition to the connectors 26, 28 of the first linkage 22. At the rearwardly directed ends of the connectors 40, 42, the connectors 40, 42 are connected in an articulated manner to a connector 46 extending substantially vertically, such that the connectors 40, 42, 46 and the common connector 34 also form a parallelogram linkage, if only the region between a point of securing to the connector 46 and the point 30 of articulation to the connector 34 is included in relation to the upper connector 40 of the second linkage 24. In this arrangement, for the second linkage 24 the common connector 34 forms a first pivotal part 48, which also makes up the pivotal part 38 of the first linkage 22, and the connector 46 forms a second pivotal part 50. The pivotal part 38 of the first linkage 22 and the first pivotal part 48 of the second linkage 24 thus coincide here, at the common connector 34.

The first linkage 22 and the second linkage 24 are connected to one another by way of a joining connector 52. For this purpose, the joining connector 52 is coupled at one end in an articulated manner to the lower connector 28 of the first linkage 22 at an articulation point 54 in a central region thereof. At the other end, the joining connector 52 is coupled in an articulated manner to the prolonged portion 44 at an articulation point 56 at the end thereof. The joining connector 52 couples the first and the second linkages 22, 24 to one another such that a pivotal movement of the first linkage 22 triggers a pivotal movement of the second linkage 24.

The connectors 26, 28, 34, 40, 42, 46, 52 may for example take the form of flat, angled or tubular profiles, wherein their constructions are of different thicknesses depending on their static and dynamic loads.

Further provided is a servo motor 58 which extends between the frame 12, or the secured part 36, and the lower connector 28 of the first linkage 22 and is connected in an articulated manner to both of these. The servo motor 58 serves to apply an actuating force of the servo motor 58 to the first linkage 22.

As illustrated in FIG. 1, the servo motor 58 takes the form of a hydraulic cylinder and is controlled by way of a hydraulic control (not shown) for raising and lowering the first linkage 22. As a result of the servo motor 58 being extended and retracted, the lower connector 28 of the first linkage 22 is pivoted and the first linkage 22 (parallelogram linkage) is raised and lowered on the frame 12, or on the secured part 36, about the securing points of the upper and lower connectors 26, 28. Because the connectors 26, 28, 34 are matched to one another in their length and articulation points in the manner of a parallelogram linkage, the pivotal part 38 of the first linkage 22 is displaced in terms of height while maintaining the same vertical position. During this, the articulation points 30, 32 are each moved along a circular path having a circle center situated on the frame 12 at the respective securing points. During this, the articulation point 30 moves with the pivotal part 38 and in so doing, changes its distance from the point 54 of articulation to the lower connector 28 of the first linkage 22. At the same time, the distance from the articulation point 56 to the articulation point 54 is kept constant by the joining connector 52. This has the effect that a pivotal movement of the upper connector 40 of the second linkage 24, applied by the joining connector 52, is performed about the articulation point 30. By means of the parallelogram arrangement of the second linkage 24, the lower connector 42 of the second linkage 24 is pivoted correspondingly and parallel to the connector 40, about the articulation point 32. Because the connectors 40, 42, 34 are matched to one another in their length and articulation points in the manner of a parallelogram linkage, the connector 46 of the second linkage 24, and hence the second pivotal part 50 of the second linkage 24, are displaced in terms of height while maintaining the same vertical position in relation to the surface of the ground. During this, the points at which the connectors 40, 42 are secured to the second pivotal part 50 are each shifted along a path which is the overall resultant in relation to the frame 12, or in relation to the secured part 36, this path extending almost in a straight line. The path which is an overall resultant in relation to the frame 12 results from the shifts of the articulation points 30, 32 in relation to the frame 12 along their circular paths, and the shifts of the points at which the connectors 40, 42 are secured to the second pivotal part 50 of the second linkage 24 in relation to the pivotal part 38 of the first linkage 22. The straightness of the path which is a resultant in relation to the frame 12, and hence the almost vertical displacement of the second pivotal part 50 of the second linkage 24, is shown by the dashed line of the linkage arrangement 18 in the raised position in FIG. 1. When the linkage arrangement 18 is moved by the servo motor 58, there is only a small horizontal shift of the second pivotal part 50 of the second linkage 24 (compare the dashed line of the raised condition to the solid line of the lowered condition of the linkage arrangement).

The agricultural machine 10 illustrated in FIG. 1 is equipped on either side with a linkage arrangement 18, and these are connected to one another by way of corresponding traversing connections (not shown), for example traversing struts or a joining frame.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

Various features are set forth in the following claims.

What is claimed is:

1. An agricultural machine including a linkage arrangement for moving an attached device, the linkage arrangement comprising:
a first linkage comprising a plurality of mutually coupled connectors, a secured part secured to a frame of the machine, and a pivotal part that is pivotal in relation to the secured part;
a second linkage comprising a plurality of mutually coupled connectors, a first pivotal part which can pivot together with the pivotal part of the first linkage, and a second pivotal part that is pivotal in relation to the first pivotal part;
wherein the connectors of the first linkage extend from the secured part in the direction of the first pivotal part of the second linkage and the connectors of the second linkage extend from the first pivotal part of the second linkage in the direction of the secured part of the first linkage, and wherein a connector of the first linkage is connected to a connector of the second linkage by way of a joining connector such that they are connected to one another in an articulated manner.

2. The agricultural machine of claim 1, wherein the pivotal part of the first linkage and the first pivotal part of the second linkage are formed by a common connector.

3. The agricultural machine of claim 1, further comprising a servo motor which is connected to one of the connectors of the linkage arrangement is included.

4. The agricultural machine of claim 1, wherein the second linkage is connected to an attached device.

5. The agricultural machine of claim 1, wherein the agricultural machine takes the form of an automotive vehicle or a drawn vehicle.

6. The agricultural machine of claim 1, wherein the agricultural machine takes the form of an agricultural spraying machine.

7. The agricultural machine of claim 1, wherein the attached device is a sprayer linkage.

8. The agricultural machine of claim 1, wherein one of the pivotal part of the first linkage and the second pivotal part of the second linkage is arranged such that it is articulated substantially vertically in relation to the surface of the ground.

9. The agricultural machine of claim 1, further comprising two linkage arrangements which are arranged in parallel and extend on either side of the machine and are provided to move an attached device.

10. The agricultural machine of claim 1, wherein one of the first and second linkages takes the form of a parallelogram linkage.

11. The agricultural machine of claim 1, wherein the first and second linkages take the form of a parallelogram linkage.

12. The agricultural machine of claim 11, wherein the first and the second parallelogram linkages each have an upper connector and, guided parallel thereto, a lower connector , wherein the joining connector extends from the lower connector of the first parallelogram linkage to the upper connector of the second parallelogram linkage.

13. The agricultural machine of claim 12, wherein one of the upper and lower connectors of the first or second parallelogram linkage has a portion which is prolonged by comparison with the lower connector or upper connector respectively of the corresponding parallelogram linkage, and the joining connector is articulated to this prolonged portion.

14. The agricultural machine of claim 11, wherein the first and the second parallelogram linkages each have an upper connector and, guided parallel thereto, a lower connector, wherein the joining connector extends from the upper connector of the first parallelogram linkage to the lower connector of the second parallelogram linkage.

15. The agricultural machine of claim 14, wherein one of the upper or lower connectors of the first or second parallelogram linkage has a portion which is prolonged by comparison with the lower connector or upper connector respectively of the corresponding parallelogram linkage, and the joining connector is articulated to this prolonged portion.
